(19) United States
(12) Patent Application Publication
(10) Pub. No.: US 2026/0148609 A1
(43) Pub. Date: May 28, 2026

(54) REMOTE WAGERING GAME SYSTEM OPERABLE WITH UNIVERSAL INTERFACE PLUGIN

(71) Applicant: Brightstar Global Solutions Corporation, Providence, RI (US)

(72) Inventors: Liberato Lombardi, Vallmontone (IT); Tommaso Mazzarotto, Rome (IT)

(21) Appl. No.: 18/958,718

(22) Filed: Nov. 25, 2024

(51) Int. Cl. G07F 17/32

(52) U.S. Cl. CPC G07F 17/3225

(57) ABSTRACT

A remote wagering game system and methods of operating a remote wagering game system operable with a universal interface plugin.

### BACKGROUND

The present disclosure relates to remote wagering gaming systems with a universal interface plugin.

Remote wagering game systems may communicate with different first player electronic devices that have different user interfaces to provide different games.

### BRIEF SUMMARY

In various embodiments, the present disclosure relates to a remote wagering gaming system including a native remote gaming server operable to send a first copy of a universal interface plugin to a first player electronic device. The first copy of the universal interface plugin is executable to enable a third party hosted game to be played via a first player user interface displayed by the first player electronic device. The native remote gaming server is operable to send a second copy of the universal interface plugin to a second player electronic device. The second copy of the universal interface plugin is executable to enable the same third party hosted game to be played via a second player user interface displayed by the second player electronic device. The first player user interface is different than the second player user interface. The native remote gaming server is operable, responsive to a first game launch request by the first player electronic device for the third party hosted game, to send the first copy of the universal interface plugin to the first player electronic device, such that the first copy of the universal interface plugin sent to the first player electronic device can be integrated with the first player user interface based on the first game launch request. The native remote gaming server is operable, responsive to a second game launch request by the second player electronic device for the third party hosted game, to send the second copy of the universal interface plugin to the second player electronic device, such that the second copy of the universal interface plugin sent to the second player electronic device can be integrated with the second player user interface based on the second game launch request.

In various other embodiments, the present disclosure relates to a remote wagering game system including a native remote gaming server operable to send a first copy of a universal interface plugin to a first player electronic device. The first copy of the universal interface plugin is executable to enable a third party hosted game to be played a via a first player user interface displayed by the first player electronic device. The native remote gaming server is operable, responsive to a first game launch request by the first player electronic device for the third party hosted game, to send the first copy of the universal interface plugin to the first player electronic device, such that the first copy of the universal interface plugin sent to the first player electronic device can be integrated with the first player user interface based on the first game launch request. The native remote gaming server is operable to send a first copy of a game wrapper to the first player electronic device responsive to the first game launch request by the first player electronic device for the third party hosted game. The first copy of the game wrapper is executable to integrate the first copy of the universal interface plugin with the first player user interface. The native remote gaming server is operable to send a second copy of the universal interface plugin to a second player electronic device. The second copy of the universal interface plugin is executable to enable the same third party hosted game to be played a via a second player user interface displayed by the second player electronic device. The first player user interface is different than the second player user interface. The native remote gaming server is operable, responsive to a second game launch request by the second player electronic device for the third party hosted game, to send the second copy of the universal interface plugin to the second player electronic device, such that the second copy of the universal interface plugin sent to the second player electronic device can be integrated with the second player user interface based on the second game launch request. The native remote gaming server is operable to send a second copy of the game wrapper to the second player electronic device responsive to the second game launch request by the second player electronic device for the third party hosted game. The second copy of the game wrapper is executable by the second player electronic device to integrate the second copy of the universal interface plugin with the second player user interface.

In various other embodiments, the present disclosure relates to remote wagering game system including a native remote gaming server operable to send a first copy of a universal interface plugin to a first player electronic device. The first copy of the universal interface plugin is executable to enable a hosted game to be played a via a first player user interface displayed by the first player electronic device. The native remote gaming server is operable to send a second copy of the universal interface plugin to a second player electronic device. The second copy of the universal interface plugin is executable to enable the same hosted game to be played a via a second player user interface displayed by the second player electronic device. The first player user interface is different than the second player user interface. The native remote gaming server is operable, responsive to a first game launch request by the first player electronic device for the hosted game, to send the first copy of the universal interface plugin to the first player electronic device, such that the first copy of the universal interface plugin sent to the first player electronic device can be integrated with the first player user interface based on the first game launch request. The native remote gaming server is operable, responsive to a second game launch request by the second player electronic device for the hosted game, to send the second copy of the universal interface plugin to the second player electronic device, such that the second copy of the universal interface plugin sent to the second player electronic device can be integrated with the first player user interface based on the second game launch request.

Additional features are described in, and will be apparent from, the following Detailed Description and the figures.

### BRIEF DESCRIPTION OF THE SEVERAL VIEWS OF THE DRAWINGS

FIG. 1 is a diagrammatic view of a first known remote wagering game system, showing separate gaming operator systems that serve different player user interfaces.

FIG. 2 is a diagrammatic view of a second known remote wagering game system, showing an application programming interface for data communicated between different remote game servers that serve a same player user interface.

FIG. 3 is a diagrammatic view of an example remote wagering game system that includes a first remote gaming server operable with a universal interface plugin, a third party remote gaming server that hosts a game operable with the universal interface plugin, and a first player account management server, in accordance with one example embodiment of the present disclosure.

FIG. 4 is a flow diagram showing one example method of operation of the remote wagering game system of FIG. 3 in accordance with one example embodiment of the present disclosure.

### DETAILED DESCRIPTION

In various embodiments, the present disclosure relates to a remote wagering game system and methods of operating a remote wagering game system operable with a universal interface plugin.

In various embodiments, the remote wagering game system is configured to communicate with a plurality of different and separate player electronic devices that are each configured to display a player user interface and enable a user of that player electronic device to play a game via the player user interface of that player electronic device. While the remote wagering game system is configured to communicate with a plurality of player electronic devices, two different player electronic devices are used as the primary example herein for brevity, but are not meant to limit the present disclosure.

In various embodiments, the remote wagering game system includes: (a) one or more remote gaming servers that each host one or more different games that are playable via different player user interfaces of the player electronic devices; (b) a single universal interface plugin that facilitates operation of a game via each of the different player user interfaces; and (c) one or more player account management servers

In various embodiments, the remote wagering game system includes: (a) one or more remote gaming servers; (b) one or more third party gaming servers that each host one or more different games that are playable via different player user interfaces of different player electronic devices; (c) a single universal interface plugin that facilitates operation of the different games via each of the different player user interfaces of the different player electronic devices; and (d) one or more player account management servers. The single universal interface plugin enables the third party game servers to host one or more games that is/are playable via multiple different player user interfaces of different player electronic devices.

For a better understanding of the present disclosure, two known remote wagering game systems are first described below.

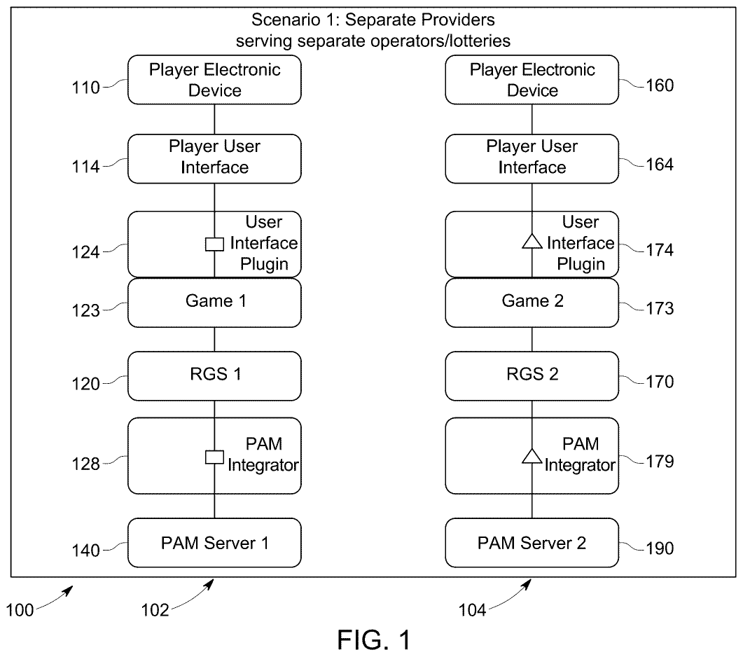

FIG. 1 shows a first known remote wagering game system 100. This known system includes: (a) a first remote gaming server 120 (“first RGS”) configured to communicate with a first player electronic device 110 (such as a smartphone or tablet); and (b) a first player account management (“first PAM”) server 140. The first RGS 120 and the first PAM server 140 are associated with a first gaming operator system 102.

The first player electronic device 110 includes a processor and a memory (not shown) that stores instructions that, when executed by the processor, enable the functionality described herein. The first player electronic device 110 is configured to display a first player user interface 114, such as a graphical user interface of an application, a web browser or other application that displays web page(s), or another suitable user interface portal. The first player user interface 114 includes one or more user interface widgets that facilitate user interactions with the first player electronic device 110. Widgets that facilitate interaction with the user can include menus, buttons, scroll bars, and message boxes. Widgets that facilitate graphical organization by grouping together other widgets can include windows, pop-ups, frames, panels, and tabs. The first player user interface 114 enables a user of the first player electronic device 110 to: (a) select a game to play; (b) play and interact with the selected game (such as provide user inputs such as placing a wager for the selected game); (c) view information associated with the selected game via one or more widgets (such as view a game outcome in a message box); and (d) perform other suitable user interactions.

The first RGS 120 includes a processor and a memory (not shown) that stores instructions that, when executed by the processor, enable the functionality described herein. The first RGS 120 hosts different games, including a first game 123, that are playable via the first player user interface 114. The first game 123 (shown as “Game 1”) includes instructions that when executed by one or more processors, cause and/or configure the processor(s) to perform the first game 123. In various examples, instructions of the first game 123 are executed by: (a) the first player electronic device 110 (e.g., as a standalone client application); (b) the first RGS 120 (e.g., as a standalone server application); or (c) the first player electronic device 110 and the first RGS 120 (e.g., as a client side part and server side part of an application).

The first RGS 120 stores a first user interface plugin 124 that enables communication of data, specific to the first game 123, with the first player electronic device 110. The first RGS 120 employs the first user interface plugin 124 to cause the first player electronic device 110, via the first player user interface 114, to: (a) display the first game 123; (b) receive user inputs for the first game 123 from the user of the first player electronic device 110; (c) display information associated with the first game 123 (such as a game outcome message of “You won 30 credits!”); and/or other suitable game operations. In various embodiments, the first user interface plugin 124 includes instructions that when executed by one or more processors, cause and/or configure the processor(s) to provide the functionality described herein. In various examples, instructions of the first user interface plugin 124 are executed by: (a) the first player electronic device 110; (b) the first RGS 120; or (c) the first player electronic device 110 and the first RGS 120. In various embodiments, the remote wagering game system 100 employs a separate copy of all or a portion of the first user interface plugin 124 for each instance of the first game 123 when being played by additional player electronic devices.

For the different games hosted by the first RGS 120, the first RGS 120 includes a user interface plugin for communication with the first player user interface 114. In other words, the first user interface plugin 124 includes instructions that are specific to the games hosted by the first RGS 120 (i.e., the first game 123) and specific to the first player user interface 114.

The first RGS 120 includes a first PAM integrator 128 that enables communication with the first PAM server 140 to facilitate authentication of a player (such as a user of the first player electronic device 110), authorization for playing games hosted by the first RGS 120, adjusting account balances (such as wagers, credits, and transfers), and other suitable player account operations. The first PAM integrator 128 includes instructions that are specific to the first PAM server 140 and specific to the first RGS 120.

The first PAM server 140 includes a processor and a memory that stores instructions that, when executed by the processor, enable the functionality described herein. The first PAM server 140 manages player accounts for players of the games hosted by the first RGS 120, such as a player account for the user of the first player electronic device 110. For example, the PAM server 140 stores player account identifiers, passwords, account balances for a player account (such as credits or currency).

The remote wagering game system 100 shown in FIG. 1 also includes: (c) a second remote gaming server 170 (“second RGS”) configured to communicate with a second player electronic device 160; and (d) a second PAM server 190. The second RGS 170 and the second PAM server 190 are associated with a second gaming operator system 104 that is different from the first gaming operator system 104.

The second RGS 170 hosts different games, including a second game 173 that is different from the first game 123, that are playable via a second, different player user interface 164 displayed by the second player electronic device 160. The second RGS 170 includes a second user interface plugin 174 that enables communication of data, specific to the second game 173 (shown as “Game 2”), with the second player electronic device 160. The second user interface plugin 174 includes instructions that are specific to the second game 173 and specific to the second player user interface 164. The second RGS 170 also includes a second PAM integrator 179 having instructions that are specific to the second PAM server 190 and specific to the second RGS 170. In other words, the second RGS 170 cannot directly or indirectly communicate with the first PAM server 140 using the second PAM integrator 179 (e.g., due to their having different software stacks and/or implementations).

In this first example, the first player user interface 114 is associated with a first aesthetic theme such that different user interface widgets of the first player user interface 114, when displayed, are displayed with a desired visual style. For example, the first aesthetic theme can include one or more of font faces, font sizes, color palettes for windows and/or buttons, or other suitable aesthetic elements to be used when displaying a user interface widget. On the other hand, the second player user interface 164 is associated with a second, different aesthetic theme. The first player user interface 114 and the second player user interface 164 can also be associated with different software backends (or software stacks), different hardware on which the software backends are executed, and/or other differences. In various embodiments, the first player user interface 114 and the second player user interface 164 include different user interface features, such as timed pop-ups or other suitable messages.

Due at least in part to multiple differences between the first and second player user interfaces 114 and 164 (such as aesthetic themes, software backends, and/or hardware): (1) the first user interface plugin 124 is specific to the games hosted by the RGS 120 (e.g., the first game 123) when operated with the first player user interface 114; and (2) the second user interface plugin 174 is specific to the games hosted by the RGS 170 (e.g., the second game 173) when operated with the second player user interface 164. In other words, the first and second user interface plugins 124 and 174 are not interchangeable and must be developed, updated, and otherwise maintained separately.

In this first example, a user of first player electronic device 110 is unable to play the second game 173 because integration of the second game 173 to a player user interface is performed by the second user interface plugin 174, which is specific to the second player user interface 164. Additionally, the second RGS 170 is unable to authenticate the user of the first player electronic device 110 because the second RGS 170 cannot directly communicate with the first PAM server 140 (such as the second PAM integrator is specific to the second PAM server 190).

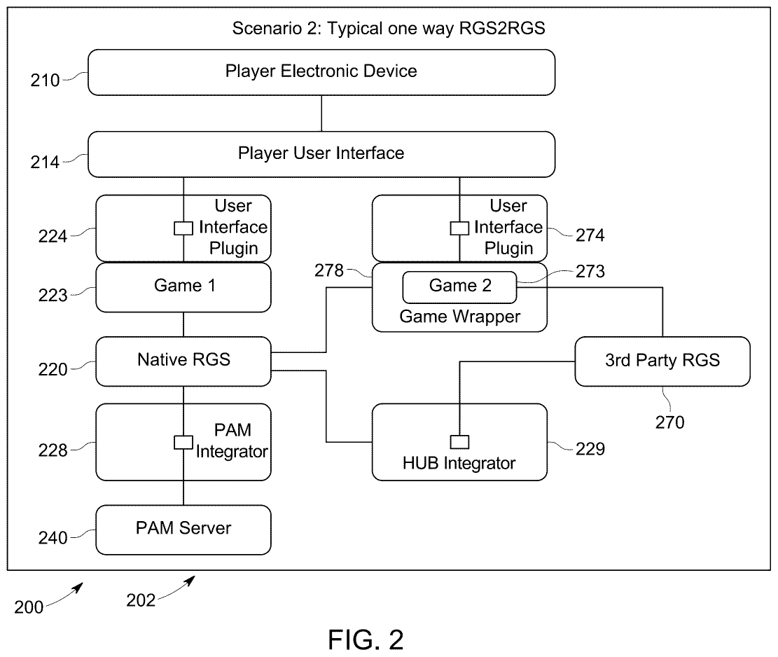

FIG. 2 shows a second known remote wagering game system 200. This system 200 includes: (a) a first RGS 220 configured to communicate with a first player electronic device 210; (b) a first PAM server 240; and (c) a second RGS 270. The first RGS 220 and the first PAM server 240 are associated with a first gaming operator system 202 and are configured to exchange data to facilitate gaming activities. In other words, the first RGS 220 is native to the first gaming operator system 202. The first RGS 220 is also referred to herein as a “native RGS” 220.

The first player electronic device 210 includes a processor and a memory (not shown) that stores instructions that, when executed by the processor, enable the functionality described herein. The first player electronic device 210 is configured to display a first player user interface 214.

The native RGS 220 includes a processor and a memory (not shown) that stores instructions that, when executed by the processor, enable the functionality described herein. The native RGS 220 hosts a first game 223 that is playable via the first player user interface 214 using a first user interface plugin 224. The native RGS 220 includes a first PAM integrator 228 that enables direct communication with the first PAM server 240.

The second RGS 270 (referred to herein as a “third party RGS”) hosts a second game 273 and, in this second example, the second game 273 is playable via the first player user interface 214 using a second user interface plugin 274. The third party RGS 270 is not associated with the first gaming operator system 202 and does not include a PAM integrator associated with the PAM server 240. Without this PAM integrator, the third party RGS 270 cannot directly communicate with the first PAM server 240 for authentication, authorization, and/or other player account operations.

To enable a user of the first player electronic device 210 to play the second game 273 hosted by the third party RGS 270, the native RGS 220 in this second example includes the second user interface plugin 274, a game wrapper 278, and a hub integrator 229. The hub integrator 229 facilitates communication between the third party RGS 270 and the first PAM server 240 (such as for authentication, authorization, and/or other player account operations). In various embodiments, the native RGS 220 employs the hub integrator 229 to translate, convert, and/or process data communicated between the first PAM server 240 and the third party RGS 270. The hub integrator 229 includes instructions that when executed by one or more processors, cause and/or configure the processor(s) to provide the functionality described herein. In various examples, instructions of the hub integrator 229 are executed by: (a) the native RGS 220 and the third party RGS 270; (b) the third party RGS 270; or (c) the native RGS 220.

The game wrapper 278 is associated with the second game 273. The game wrapper 278 is specific to the native RGS 220 and the second game 273 and can include an application programming interface (API) or other suitable software intermediary that facilitates communication between the second game 273 and the native RGS 220. In various embodiments, the game wrapper 278 is configured to translate, convert, and/or otherwise process data communicated between the second game 273 and the native RGS 220. The second user interface plugin 274 enables communication between the first player user interface 214 and the second game 273 (such as via the game wrapper 278).

In this second example, the third user interface plugin 274 is specific to the second game 273 when operated with the first player user interface 214 and with the game wrapper 278. The third user interface plugin 274 is not interchangeable with the first user interface plugin 224 and must be developed, updated, and maintained separately. Although the third user interface plugin 274 enables playing the second game 273 via the first player user interface 214, playing the second game 273 via a different player user interface requires additional user interface plugins.

In the first example described above, the second game 173 is not playable on the first player electronic device 110 via the first player user interface 114. In the second example described above, the second game 273 is playable via the first player user interface 214, but additional development and maintenance costs associated with the third user interface plugin 274 are incurred. To enable the second game 273 to be played on any additional player user interfaces (not shown), further development and maintenance costs are incurred for different user interface plugins for each of such additional player user interfaces.

Various embodiments of the present disclosure alleviate one or more development, updating, and/or maintenance issues of the second example by employing a single, universal interface plugin that is operable with two, three, or more different player user interfaces for different player electronic devices. That is, the universal interface plugin is a reusable interface plugin that provides a universal protocol with which any game provider can configure its games to operate.

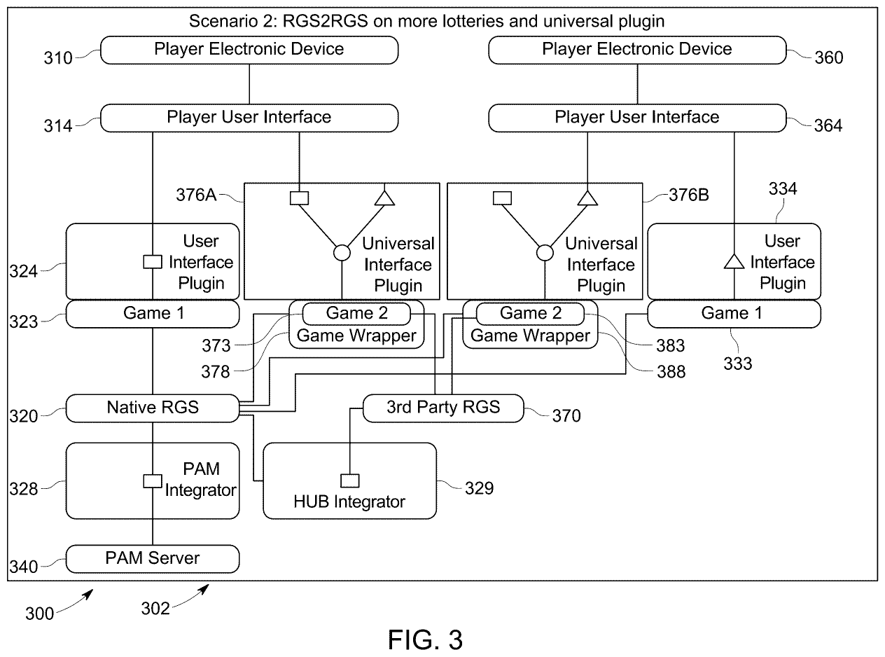

FIG. 3 shows an example remote wagering game system 300 that enables playing different games hosted by different remote game servers via different player user interfaces using a universal interface plugin 376 in accordance with one example embodiment of the present disclosure.

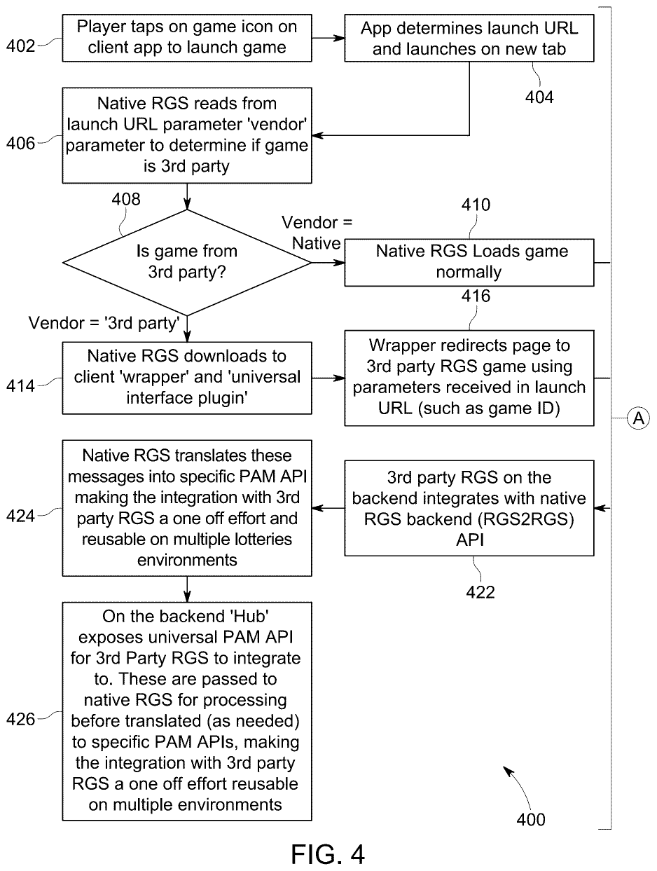

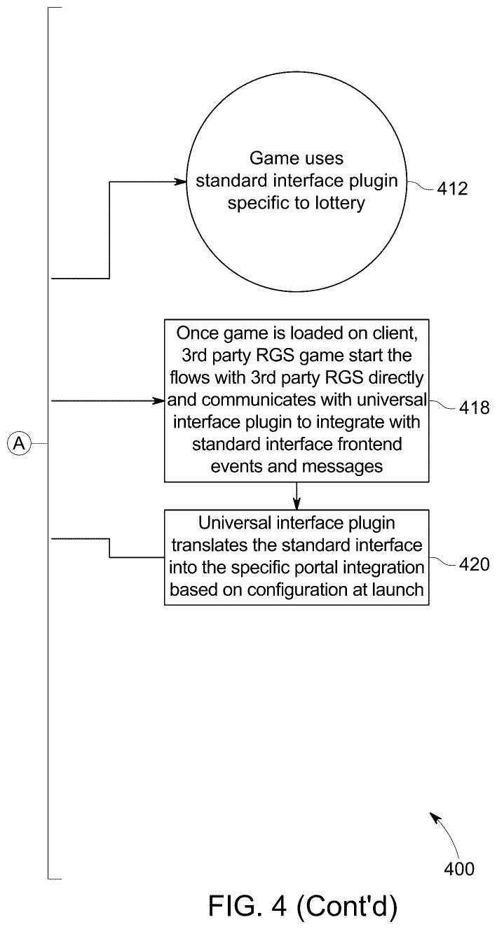

FIG. 4 illustrates an example method 400 of operating the example remote wagering game system 300 in accordance with one example embodiment of the present disclosure.

The universal interface plugin 376 includes instructions stored on a suitable memory device that, when executed by one or more processors, provide the functionality described herein. In certain embodiments, the remote wagering game system 300 employs copies of the universal interface plugin 376 (such as different copies of the instructions in different memory device locations). In the example embodiment described below, the remote wagering game system 300 employs: (1) a first copy of the universal interface plugin 376, referred to herein as universal interface plugin 376A; and (2) a second copy of the universal interface plugin 376, referred to herein as universal interface plugin 376B.

The remote wagering game system 300 includes: (a) a first RGS 320; (b) a PAM server 340; (c) a second RGS 370; and (d) the single, universal interface plugin 376. The first RGS 320 and the first PAM server 340 are associated with a first gaming operator system 302 and are configured to exchange data with each other to facilitate gaming activities. In other words, the first RGS 320 is native to the first gaming operator system 302 and the first RGS 320 and the first PAM server 340 are members of the first gaming operator system 302. The first RGS 320 is also referred to herein as a “native RGS” 320. In this embodiment, the native RGS 320 is configured to communicate with a first player electronic device 310 and a second player electronic device 360.

Each of the first player electronic device 310 and the second player electronic device 360 includes a processor and a memory (not shown) that stores instructions that, when executed by that processor, enable the functionality described herein. The first player electronic device 310 is configured to display a first player user interface 314 and the second player electronic device 360 is configured to display a second, different player user interface 364. In various embodiments, the first and second player user interfaces 314 and 364 employ different aesthetic themes, software backends, processor architectures on which the software backends are executed (e.g., Qualcomm Snapdragon processors, Samsung Exynos processors, ARM-based processors), and/or other differences. In various embodiments, the first and second player user interfaces 314 and 364 employ different user interface features and/or different timings for such user interface features, such as pop-up windows, notifications, inactivity time-out prompts, or other suitable features. In various embodiments, the first and second player electronic devices 310 and 360 include Android-based devices, iOS-based devices, Fire OS-based devices, ChromeOS-based devices, and/or other suitable electronic devices. In certain embodiments, the first and second player electronic devices 310 and 360 have a same operating system (e.g., Android-based devices), but the first and second player user interfaces 314 and 364 are different from each other. In certain embodiments, the first and second player electronic devices 310 and 360 have different operating systems and/or processors, but the first and second player user interfaces 314 and 364 are visually the same.

The native RGS 320 includes a processor and a memory (not shown) that stores instructions that, when executed by the processor, enable the functionality described herein. The native RGS 320 includes: (a) a first game 323; (b) a game wrapper 378 for a different, second game 373; (c) the universal interface plugin 376; (d) a PAM integrator 328; and (e) a hub integrator 329. In various embodiments, the native RGS 320 employs one or more copies of the first game 323, the game wrapper 378, and/or the universal interface plugin 376, as described below. In the example embodiment, the native RGS 320 employs a second copy 333 of the first game (shown as first game 333), a second copy 388 of the game wrapper (shown as game wrapper 388), and the second copy 376B of the universal interface plugin 376 (shown as universal interface plugin 376B).

The native RGS 320 hosts the first game 323 to be playable by the first and second player electronic devices 310 and 360. As shown in the example embodiment in FIG. 3, the native RGS 320 includes the first copy of the first game 323 that is playable via the first player user interface 314 using a first user interface plugin 324. The native RGS 320 also includes the first game 333 (i.e., the second copy of the first game 323) that is playable via the second player user interface 364 using a second, different user interface plugin 334. In various embodiments, the first game 323 includes a draw game, a scratch-off game, a reel game, a slot game, a card game, or other suitable wagering game. In various embodiments, the first game 323 includes a non-wagering game, a cooperative game (such as with multiple players on a same device and/or different devices), or other suitable game.

The native RGS 320 includes the first user interface plugin 324, which enables communication of data, specific to the first game 323 when played through the first player user interface 314, with the first player electronic device 310. The native RGS 320 employs the first user interface plugin 324 to cause the first player electronic device 310, via the first player user interface 314, to: (a) display the first game 323; (b) receive user inputs for the first game 323 from the user of the first player electronic device 310; (c) display information associated with the first game 323; and/or other suitable game operations. The native RGS 320 also includes the second user interface plugin 334 that enables communication of data specific to the first game 333 when played through the second player user interface 364.

The native RGS 320 includes the game wrapper 378, which is associated with the second game 373, described below. The game wrapper 378 is specific to the native RGS 320 and the second game 373 and can include an application programming interface (API) or other suitable software intermediary that facilitates communication between the second game 373 and the native RGS 320. In various embodiments, the game wrapper 378 is configured to translate, convert, and/or otherwise process data communicated between the second game 373 and the native RGS 320. As shown in the example embodiment in FIG. 3, the native RGS 320 employs the game wrapper 378 for the second game 373 and the game wrapper 388 (i.e., the second copy of the game wrapper 378) for the second game 383 (i.e., the second copy of the second game 373). In certain embodiments, the game wrapper 378 is executable by a player electronic device (e.g., player electronic device 310 or 360) to enable and/or integrate different frontend interfaces of the universal interface plugin 376 with different player user interfaces, as described below.

The universal interface plugin 376 is configured to enable communication between different player user interfaces and the second game 373. In the embodiment shown in FIG. 3, the universal interface plugin 376 includes a third party interface or application programming interface (shown as a circle) for communication with games of one or more third party RGS(s). The third party interface is executable to receive input gaming data associated with the second game 373 from the third party RGS 370 that hosts the second game 373. The input gaming data can include messages to be provided to a user of the player electronic device, user interface display data to be displayed by the player electronic device, audio data to be played back by the player electronic device, or other suitable game data.

The universal interface plugin 376 also includes a plurality of frontend interfaces. In the embodiment shown in FIG. 3, the universal interface plugin 376 includes a first frontend interface associated with the player user interface 314 (shown as a square) and a second frontend interface associated with the player user interface 364 (shown as a triangle). The first frontend interface is configured to enable the user interface features of the player user interface 314 and/or timings for such user interface features when playing the second game 373 via the player user interface 314. In certain embodiments, the first frontend interface is executable to send first interface gaming data associated with the second game 373 to the first player user interface 314. In such embodiments, the universal interface plugin 376 is executable to translate input gaming data to the first interface gaming data. Similarly, the second frontend interface is configured to enable the user interface features of the player user interface 364 and/or timings for such user interface features when playing the second game 383 via the player user interface 364. In certain embodiments, the second frontend interface is executable to send second interface gaming data associated with the second game 373 to the second player user interface 364. In such embodiments, the universal interface plugin 376 is executable to translate input gaming data to the second interface gaming data. In various embodiments, the different frontend interfaces are selectable based on runtime parameters, as described below.

As shown in FIG. 3, the native RGS 320 employs the universal interface plugin 376A (i.e., the first copy of the universal interface plugin 376) and the universal interface plugin 376B (i.e., the second copy of the universal interface plugin 376). In various examples, instructions of the universal interface plugin 376A are executed by: (a) the first player electronic device 310; (b) the native RGS 320; or (c) the first player electronic device 310 and the native RGS 320. In various examples, instructions of the universal interface plugin 376B are executed by: (a) the second player electronic device 360; (b) the native RGS 320; or (c) the second player electronic device 360 and the native RGS 320.

The PAM integrator 328 is configured to enable direct communication with the first PAM server 340 to facilitate authentication of a player (such as users of the player electronic devices 310 and 360), authorization for playing games hosted by the native RGS 320 and/or third party RGS 370, adjusting account balances, and other suitable player account operations. The PAM integrator 328 includes instructions that when executed by one or more processors, cause and/or configure the processor(s) to provide the functionality described herein. The PAM integrator 328 includes instructions that are specific to the PAM server 340 and specific to the native RGS 320. In various examples, instructions of the PAM integrator 328 are executed by: (a) the native RGS 320; (b) the PAM server 340; or (c) the native RGS 320 and the PAM server 340.

The hub integrator 329 is configured to translate, convert, and/or process data communicated between the first PAM server 340 and one or more third party RGS(s). The hub integrator 329 includes instructions that when executed by one or more processors, cause and/or configure the processor(s) to provide the functionality described herein. In various examples, instructions of the hub integrator 329 are executed by: (a) the native RGS 320; (b) the third party RGS 370; or (c) the native RGS 320 and the third party RGS 370. In various embodiments, the hub integrator 329 includes an RGS to RGS application programming interface (also referred to as “RGS2RGS”).

The first PAM server 340 includes a processor and a memory that stores instructions that, when executed by the processor, enable the functionality described herein. The first PAM server 340 is configured to manage player accounts for players of the games hosted by the native RGS 320, such as player accounts for the users of the first player electronic device 310 and the second player electronic device 360. For example, the PAM server 340 stores player account identifiers, passwords, account balances for a player account (such as credits or currency).

The second RGS 370 (referred to as a “third party RGS”) hosts the second game 373. In this example embodiment, the second game 373 is playable via the first player user interface 314 and via the second player user interface 364. The third party RGS 370 employs copies of the second game 373 for each instance of the second game 373 being played. As shown in the example embodiment in FIG. 3, the third party RGS 370 employs the second game 373 (i.e., the first copy) that is playable via the first player user interface 314. The third party RGS 370 also employs the second game 383 (i.e., the second copy) that is playable via the second player user interface 364. In various embodiments, the second game 373 includes a reel game, slot game, card game, instant game (e.g., with a scratch card game appearance) or other suitable wagering game. In various embodiments, the second game 373 includes a non-wagering game, a cooperative game (such as with multiple players on a same device and/or different devices), or other suitable game.

In this example embodiment, the third party RGS 370 is not a member of the first gaming operator system 302 and does not include a PAM integrator associated with the PAM server 340. Without this PAM integrator, the third party RGS 370 cannot directly communicate with the first PAM server 340 for authentication, authorization, and/or other player account operations.

In this example embodiment, the universal interface plugin 376 enables the second game 373 to be playable via both the first player user interface 314 and the second player user interface 364. In other words, the universal interface plugin 376 includes a single interface plugin that enables the second game 373 to be playable in different player user interfaces, instead of employing separate user interface plugins for each player user interface (such as the second user interface plugin 174 of the first example and the third user interface plugin 274 of the second example).

The universal interface plugin 376 enables communication between the first player user interface 314 and the second game 373 (such as via the game wrapper 378) and communication between the second player user interface 364 and the second game 383 (such as via the game wrapper 388). In various embodiments, the universal interface plugin 376 can also be employed with additional player user interfaces (not shown) without requiring a separate user interface plugin for each such additional player user interface. In this example embodiment, the native RGS 320 stores the universal interface plugin 376 and the game wrapper 378 and is configured to provide copies of the universal interface plugin 376 and game wrapper 378 to the first player electronic device 310, the second player electronic device 360, or other suitable electronic devices.

To support different player user interfaces, the native RGS 320 causes different instances (such as different copies of the instructions in different memory locations) of the universal interface plugin 376 to be loaded, instantiated, and/or initialized with different parameters (e.g., runtime parameters). In the embodiment shown in FIG. 3, the native RGS 320 loads the first universal interface plugin 376A with runtime parameters associated with the player user interface 314 and loads the second universal interface plugin 376B with runtime parameters associated with the second player user interface 364. In various embodiments, the native RGS 320 is configured to load additional copies of the universal interface plugin 376 using different runtime parameters for additional player user interfaces. In certain embodiments, the native RGS 320 employs the game wrapper 378 to load the universal interface plugin based on the runtime parameters.

Turning now to FIG. 4, an example method 400 of operating the remote wagering game system 300 is now described. Although the method is described with reference to the flowchart shown in FIG. 4, other methods of performing the acts associated with this illustrated process may be employed. For example, the order of certain of the illustrated blocks and diamonds may be changed, certain of the illustrated blocks and diamonds may be optional, or certain of the illustrated blocks and diamonds may not be employed.

Two examples are described in which a user (such as a player) of the first player electronic device 310 begins to play a game hosted by: (1) the native RGS 320 (first example); or (2) the third party RGS 370 (second example). A third example is then described in which a user (i.e., player) of the second player electronic device 360 begins to play a game hosted by the third party RGS 370.

The player taps on a game icon of a client application to launch the game, as indicated at block 402. In the first example, the game includes the first game 323 and the client application includes the player user interface 314. The game icon can include a button, menu item, or other suitable graphical user interface element that is associated with the first game 323. In various examples, the player taps on a touch-screen display of the player electronic device 310, clicks with a user input device (such as mouse or keyboard), or performs another suitable user input to select the game icon associated with the first game 323.

The client application determines a launch universal resource locator (URL) and launches the launch URL on a new tab, window, frame, web page, or other suitable user interface element, as indicated at block 404. In the first example, the launch URL is associated with the game icon selected by the player and includes one or more runtime parameters that facilitate launching and/or playing the first game 323 on the player electronic device 310. The player electronic device 310 opens a new tab and loads the launch URL into the new tab.

The native RGS 320 reads a parameter “vendor” from the launch URL to determine whether the game is a third party game, as indicated at block 406. In various embodiments, the vendor parameter can include a value of “native” that is associated with games hosted by the native RGS 320 and a different value of “3rd party” that is associated with games hosted by the third party RGS 370. In this first example, the vendor parameter has a value of “native.”

The native RGS 320 determines whether or not the game is a third party game, as indicated at diamond 408. In this first example, the native RGS 320 determines that the game is not a third party game when the vendor parameter includes a value of “native” and proceeds to block 410, at which the native RGS 320 causes the first game 323 to load normally. In other words, the native RGS 320 sends data to the player electronic device 310 to launch the first game 323 in the new tab. In this first example, the native RGS 320 sends the first game 323 and the first user interface plugin 324 to the player electronic device 310.

The player electronic device 310 employs the first user interface plugin 324 to enable the player to play the first game 323 within the new tab of the player user interface 314, as indicated at block 412. In this first example, the first user interface plugin 324 includes a standard interface plugin that is specific to a particular lottery interface, specifically, the player user interface 314. In other words, the first user interface plugin 324 includes a native game user interface plugin that is operable with the first game 323 when played via the first player user interface 314, is inoperable with the other games hosted by the native RGS 320, and is inoperable with the first game 323 when played via the second player user interface 364.

Referring now to the second example, the player taps on a game icon of a client application to launch the game, as indicated at block 402. In this second example, the game selected by the player of the player electronic device 310 includes the second game 373 hosted by the third party RGS 370 and the client application includes the player user interface 314.

The client application determines a launch URL and launches a new tab, window, frame, web page, or other suitable user interface element, as indicated at block 404. The launch URL is referred to herein as a game launch request.

The native RGS 320 reads a parameter “vendor” from the launch URL to determine whether the game is a third party game, as indicated at block 406. In this second example, the vendor parameter has a value of “third party.”

The native RGS 320 determines whether or not the game is a third party game, as indicated at diamond 408. In this second example, the native RGS 320 determines that the second game is a third party game when the vendor parameter includes the value of “third party” and proceeds to block 414, at which the native RGS 320 downloads the game wrapper 378 and the universal interface plugin 376A to the player electronic device 310. In other words, the native RGS 320 sends data to the player electronic device 310 to launch the second game 373.

The player electronic device 310 employs the game wrapper 378 to obtain the second game 373 using runtime parameters received in the launch URL, as indicated at block 416. In various embodiments, the game wrapper 378 redirects a web page within the new tab to the third party RGS 370 using a game ID parameter associated with the second game 373 and the third party RGS 370. The player electronic device 310 loads the second game 373 from the third party RGS 370 into the new tab (such as executing instructions associated with the second game 373).

After a third party game is loaded, the player electronic device employs the third party game to start a data flow with the third party RGS and communicates with the universal interface plugin to integrate with the standard interface frontend (such as events and messages specific to the player user interface), as indicated at block 418. In this second example, once the second game 373 is loaded onto the player electronic device 310, the player electronic device 310 executes instructions for the second game 373 to start a data flow with the third party RGS 370 directly. The player electronic device 310 executes instructions for the universal interface plugin 376A to integrate the second game 373 with the player user interface 314 and establish a frontend for the second game 373.

The universal interface plugin 376 translates data from the third party interface into a specific portal integration based on a configuration identified at launch, as indicated at block 420. In this second example, the universal interface plugin 376A translates from the third party interface (shown as the circle) into the first frontend interface associated with the player user interface 314 (shown as the square). As described above, the native RGS 320 loads the universal interface plugin 376A with runtime parameters associated with the player user interface 314, which enables the first frontend interface (shown as the square) for that instance of the universal interface plugin 376A.

Once the frontend for the third party game is established, the third party RGS integrates with the native RGS to establish a backend communication channel, as indicated in block 422. In the second example, the native RGS 320 and the third party RGS 370 employ the hub integrator 329 to establish the backend communication channel.

The native RGS 320 translates data and/or messages into a PAM interface that is specific to the PAM server 340, as indicated at block 424. This translation enables integration of the third party RGS 370 into the gaming operator system 302 associated with the PAM server 340 as a one off effort. The translation also enables reusability of the hub integrator 329 for backend communication channels with other third party RGS(s). In the second example, the native RGS 320 employs the hub integrator 329 to translate, convert, and/or process data communicated between the third party RGS 370 and the first PAM server 340. In various embodiments, the native RGS 320 receives data associated with a first request from the third party RGS 370 and translates the data into a second request. The native RGS 320 employs the PAM integrator 328 to send the second request to the PAM server 340.

On the backend communication channel, the hub integrator 329 exposes a universal PAM application programming interface to which a third party RGS can be integrated, as indicated at block 426. The native RGS 320 receives data and/or messages via the universal PAM API and translates the data and/or messages to the PAM interface that is specific to the PAM server (such as the PAM integrator 328). In various embodiments, the hub integrator 329 exposes the universal PAM API at block 426 prior to the translation of data and/or messages by the native RGS 320 at block 424.

Referring now to the third example, a user (such as a player) of the second player electronic device 360 begins to play a game hosted by the third party RGS 370. The player taps on a game icon of a client application to launch the game, as indicated at block 402. In this third example, the game selected by the player of the player electronic device 360 includes the second game 383 hosted by the third party RGS 370 and the client application includes the player user interface 364.

The client application determines a launch URL and launches a new tab, window, frame, web page, or other suitable user interface element, as indicated at block 404. The launch URL is referred to herein as a game launch request.

The native RGS 320 reads a parameter “vendor” from the launch URL to determine whether the second game 383 is a third party game, as indicated at block 406. In this third example, the vendor parameter has a value of “third party.”

The native RGS 320 determines whether the game is a third party game, as indicated at diamond 408. In this third example, the native RGS 320 determines that the second game 383 is a third party game when the vendor parameter includes the value of “third party” and proceeds to block 414, at which the native RGS 320 downloads the game wrapper 388 and the universal interface plugin 376B to the player electronic device 360.

As described above, the universal interface plugin 376B and the universal interface plugin 376A are both copies of a single, universal interface plugin 376 that is reusable for different player user interfaces. Once the second game 383 is configured for communication with the third party interface of the universal interface plugin 376, the second game 383 is playable on any player user interface with which the universal interface plugin 376 is operable. In other words, the remote wagering game system 300 enables a single modification the second game 383 to provide playability with a plurality of different player user interfaces.

The player electronic device 360 employs the game wrapper 388 to obtain the second game 383 using runtime parameters received in the launch URL, as indicated at block 416. In various embodiments, the game wrapper 388 redirects a web page within the new tab to the third party RGS 370 using a game ID parameter associated with the second game 383 and the third party RGS 370. The player electronic device 360 loads the second game 383 from the third party RGS 370 into the new tab (such as executing instructions associated with the second game 383).

After a third party game is loaded, the player electronic device employs the third party game to start a data flow with the third party RGS and communicates with the universal interface plugin to integrate with the standard interface frontend, as indicated at block 418. In this third example, once the second game 383 is loaded onto the player electronic device 360, the player electronic device 360 executes instructions for the second game 383 to start a data flow with the third party RGS 370 directly. The player electronic device 360 executes instructions for the universal interface plugin 376B to integrate the second game 383 with the player user interface 364 and establish a frontend for the second game 383.

The universal interface plugin 376 translates data from a standard interface into a specific portal integration based on a configuration identified at launch, as indicated at block 420. In this third example, the universal interface plugin 376B translates from the standard interface (e.g., the third party interface shown as the circle) into the second frontend interface associated with the player user interface 364 (shown as the triangle). As described above, the native RGS 320 loads the universal interface plugin 376B with runtime parameters associated with the player user interface 364, which enables the second frontend interface for that instance of the universal interface plugin 376B.

Once the frontend for the third party game is established, the third party RGS integrates with the native RGS to establish a backend communication channel, as indicated in block 422. In the third example, the native RGS 320 and the third party RGS 370 employ the hub integrator 329 to establish the backend communication channel.

The native RGS translates data and/or messages into a PAM interface that is specific to the PAM server, as indicated at block 424. This translation enables integration of the third party RGS into the gaming operator system associated with the PAM server as a one off effort. The translation also enables reusability of the hub integrator for backend communication channels with other third party RGS(s). In the third example, the native RGS 320 employs the hub integrator 329 to translate, convert, and/or process data communicated between the third party RGS 370 and the first PAM server 340. In various embodiments, the native RGS 320 receives data associated with a first request from the third party RGS 370 and translates the data into a second request. The native RGS 320 employs the PAM integrator 328 to send the second request to the PAM server 340.

On the backend communication channel, the hub integrator 329 exposes a universal PAM application programming interface to which a third party RGS can be integrated, as indicated at block 428. The native RGS 320 receives data and/or messages via the universal PAM API and translates the data and/or messages to the PAM interface that is specific to the PAM server (such as the PAM integrator 328).

In the example embodiment described above, the universal interface plugin 376 is configured to enable communication between the second game 373 and two different player user interfaces (i.e., player user interfaces 314 and 364). In various embodiments, the universal interface plugin 376 is configured to enable communication between a plurality of games hosted by the third party RGS 370 and the different player user interfaces. In certain such embodiments, each of the plurality of games is modified for communication with the third party interface of the universal interface plugin 376. In certain such embodiments, game wrappers associated with the plurality of games (such as game wrappers 378 and 388) are modified for communication with the third party interface of the universal interface plugin 376.

In various embodiments, the third party interface of the universal interface plugin includes one or more first instruction languages (such as programming languages and/or scripting languages) and each of the plurality of frontend interfaces includes one or more second instruction languages. The first and second instruction language(s) can include JavaScript, extensible markup language (XML), hypertext markup language (HTML), hypertext preprocessor (PHP), Python, cascading style sheets (CSS), and/or other suitable instruction languages. In various embodiments, the first instruction language(s) is/are different from the second instruction language(s). In various embodiments, the second instruction language(s) for different frontend interfaces include different instruction languages. As a first example, the third party interface can include JavaScript and a first frontend interface can include HTML and CSS. As a second example, the third party interface can include JavaScript, the first frontend interface can include HTML and CSS, and a second frontend interface can include PHP and XML.

In various embodiments, the native RGS 320 employs the universal interface plugin 376 for integration of games hosted by the native RGS 320 with the different player user interfaces. In other words, the native RGS 320 omits the user interface plugin 324 and the user interface plugin 334 and instead employs copies of the universal interface plugin 376 to enable integration of the first game 323 with the player user interface 314 and the player user interface 364. In such embodiments, the games hosted by the native RGS 320 are configured to integrate with the third party interface of the universal interface plugin 376.

In various embodiments, a single player electronic device loads multiple games that employ the universal interface plugin 376. In certain embodiments, the native RGS 320 sends a separate copy of the universal interface plugin 376 for each such game. In these embodiments, the player electronic device loads the different copies into different locations in memory to provide improved data privacy and/or security between different games. In certain embodiments, the native RGS 320 sends a single copy of the universal interface plugin 376. In some such embodiments, the player electronic device makes local copies of the universal interface plugin 376 in memory, with each local copy being configured for a particular game. In some such embodiments, the player electronic device loads the single copy of the universal interface plugin 376 in memory.

In the example embodiments described above, the second game 373 is different from the first game 323. In various embodiments, the first game 323 and the second game 373 include a same game title and appear to be the same game to a player, but the first game 323 and the second game 373 have different software backends and/or implementations.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A remote wagering game system comprising:
a native remote gaming server operable to send a first copy of a universal interface plugin to a first player electronic device, wherein the first copy of the universal interface plugin is executable to enable a third party hosted game to be played via a first player user interface displayed by the first player electronic device;
the native remote gaming server operable to send a second copy of the universal interface plugin to a second player electronic device, wherein the second copy of the universal interface plugin is executable to enable the same third party hosted game to be played via a second player user interface displayed by the second player electronic device, wherein the first player user interface is different than the second player user interface;
the native remote gaming server operable, responsive to a first game launch request by the first player electronic device for the third party hosted game, to send the first copy of the universal interface plugin to the first player electronic device, such that the first copy of the universal interface plugin sent to the first player electronic device can be integrated with the first player user interface based on the first game launch request; and
the native remote gaming server operable, responsive to a second game launch request by the second player electronic device for the third party hosted game, to send the second copy of the universal interface plugin to the second player electronic device, such that the second copy of the universal interface plugin sent to the second player electronic device can be integrated with the second player user interface based on the second game launch request.

2. The remote wagering game system of claim 1, wherein the first player electronic device is different from the second player electronic device.

3. The remote wagering game system of claim 1, wherein the first player user interface and the second player user interface employ different aesthetic themes, different software backends, and/or different processor architectures.

4. The remote wagering game system of claim 1, wherein the universal interface plugin comprises:
a third party interface executable to receive input gaming data associated with the third party hosted game from a third party remote gaming server that hosts the third party hosted game;
a first frontend interface executable to send first interface gaming data associated with the third party hosted game to the first player user interface, wherein the universal interface plugin is executable to translate the input gaming data to the first interface gaming data; and
a second frontend interface executable to send second interface gaming data associated with the third party hosted game to the second player user interface, wherein the universal interface plugin is executable to translate the input gaming data to the second interface gaming data.

5. The remote wagering game system of claim 4, wherein:
the native remote gaming server is operable to send a first copy of a game wrapper to the first player electronic device responsive to the first game launch request by the first player electronic device for the third party hosted game, wherein the first copy of the game wrapper is executable by the first player electronic device to enable the first frontend interface of the first copy of the universal interface plugin; and
the native remote gaming server is operable to send a second copy of the game wrapper to the second player electronic device responsive to the second game launch request by the second player electronic device for the third party hosted game, wherein the second copy of the game wrapper is executable by the second player electronic device to enable the second frontend interface of the second copy of the universal interface plugin.

6. The remote wagering game system of claim 5, wherein:
the first game launch request comprises a first runtime parameter that is used to configure the first copy of the universal interface plugin sent to the first player electronic device to integrate with the first player user interface; and
the second game launch request comprises a different second runtime parameter that is used to configure the second copy of the universal interface plugin sent to the second player electronic device to integrate with the second player user interface.

7. The remote wagering game system of claim 5, wherein:
the third party hosted game is a first third party hosted game;
the native remote gaming server is operable to send a third copy of the universal interface plugin to the first player electronic device, wherein the third copy of the universal interface plugin is executable to enable a second third party hosted game to be played via the first player user interface displayed by the first player electronic device;
the native remote gaming server is operable, responsive to a third game launch request by the first player electronic device for the second third party hosted game, to send the third copy of the universal interface plugin to the first player electronic device, such that the third copy of the universal interface plugin sent to the first player electronic device can be integrated with the first player user interface based on the third game launch request; and
the native remote gaming server is operable to send a third copy of the game wrapper to the first player electronic device responsive to the third game launch request by the first player electronic device for the second third party hosted game, wherein the third copy of the game wrapper is executable by the first player electronic device to enable the first frontend interface of the third copy of the universal interface plugin.

8. The remote wagering game system of claim 1, wherein:
the native remote gaming server hosts a first native game that is to be played via the first player user interface displayed by the first player electronic device;
the native remote gaming server is operable to send a third copy of the universal interface plugin to the first player electronic device, wherein the third copy of the universal interface plugin is executable to enable the first native game to be played via the first player user interface displayed by the first player electronic device; and
the native remote gaming server is operable, responsive to a third game launch request by the first player electronic device for the first native game, to send the third copy of the universal interface plugin to the first player electronic device, such that the third copy of the universal interface plugin sent to the first player electronic device can be integrated with the first player user interface based on the third game launch request.

9. The remote wagering game system of claim 8, wherein:
the native remote gaming server hosts a second native game that is to be played via the first player user interface displayed by the first player electronic device;
the native remote gaming server is operable to send a native game user interface plugin to the first player electronic device, wherein the native game user interface plugin is executable to enable the second native game to be played via the first player user interface displayed by the first player electronic device;
the native game user interface plugin is configured to be operable with the second native game when played via the first player user interface, is inoperable with the first native game, and is inoperable with the second native game when played via the second player user interface; and
the native remote gaming server is operable, responsive to a fourth game launch request by the first player electronic device for the second native game, to send the native game user interface plugin to the first player electronic device, such that the native game user interface plugin sent to the first player electronic device can be integrated with the first player user interface based on the fourth game launch request.

10. A remote wagering game system comprising:
a native remote gaming server operable to send a first copy of a universal interface plugin to a first player electronic device, wherein the first copy of the universal interface plugin is executable to enable a third party hosted game to be played a via a first player user interface displayed by the first player electronic device;
the native remote gaming server being operable, responsive to a first game launch request by the first player electronic device for the third party hosted game, to send the first copy of the universal interface plugin to the first player electronic device, such that the first copy of the universal interface plugin sent to the first player electronic device can be integrated with the first player user interface based on the first game launch request;
the native remote gaming server is operable to send a first copy of a game wrapper to the first player electronic device responsive to the first game launch request by the first player electronic device for the third party hosted game, wherein the first copy of the game wrapper is executable to integrate the first copy of the universal interface plugin with the first player user interface;
the native remote gaming server being operable to send a second copy of the universal interface plugin to a second player electronic device, wherein the second copy of the universal interface plugin is executable to enable the same third party hosted game to be played a via a second player user interface displayed by the second player electronic device, wherein the first player user interface is different than the second player user interface;
the native remote gaming server being operable, responsive to a second game launch request by the second player electronic device for the third party hosted game, to send the second copy of the universal interface plugin to the second player electronic device, such that the second copy of the universal interface plugin sent to the second player electronic device can be integrated with the second player user interface based on the second game launch request; and
the native remote gaming server is operable to send a second copy of the game wrapper to the second player electronic device responsive to the second game launch request by the second player electronic device for the third party hosted game, wherein the second copy of the game wrapper is executable by the second player electronic device to integrate the second copy of the universal interface plugin with the second player user interface.

11. The remote wagering game system of claim 10, wherein the universal interface plugin comprises:
a third party interface executable to receive input gaming data associated with the third party hosted game from a third party remote gaming server that hosts the third party hosted game;
a first frontend interface executable to send first interface gaming data associated with the third party hosted game to the first player user interface, wherein the universal interface plugin is executable to translate the input gaming data to the first interface gaming data; and
a second frontend interface executable to send second interface gaming data associated with the third party hosted game to the second player user interface, wherein the universal interface plugin is executable to translate the input gaming data to the second interface gaming data.

12. The remote wagering game system of claim 10, wherein:
the remote wagering game system further comprises a player account management (PAM) server operable to provide player account operations for users of the first and second player electronic devices;
the PAM server and the native remote gaming server are members of a same gaming operator system;
the third party remote gaming server is not a member of the gaming operator system; and
the native remote gaming server comprises a PAM integrator that is specific to the PAM server and the native remote gaming server and enables communication between the native remote gaming server and the PAM server for the player account operations.

13. The remote wagering game system of claim 12, wherein the native remote gaming server comprises a hub integrator executable to process data communicated between the PAM server and the third party remote gaming server to enable communication between the third party remote gaming server and the PAM server for the player account operations.

14. The remote wagering game system of claim 10, wherein the first player electronic device is different from the second player electronic device.

15. A remote wagering game system comprising:
a native remote gaming server operable to send a first copy of a universal interface plugin to a first player electronic device, wherein the first copy of the universal interface plugin is executable to enable a hosted game to be played a via a first player user interface displayed by the first player electronic device;
the native remote gaming server operable to send a second copy of the universal interface plugin to a second player electronic device, wherein the second copy of the universal interface plugin is executable to enable the same hosted game to be played a via a second player user interface displayed by the second player electronic device, wherein the first player user interface is different than the second player user interface;
the native remote gaming server operable, responsive to a first game launch request by the first player electronic device for the hosted game, to send the first copy of the universal interface plugin to the first player electronic device, such that the first copy of the universal interface plugin sent to the first player electronic device can be integrated with the first player user interface based on the first game launch request; and
the native remote gaming server operable, responsive to a second game launch request by the second player electronic device for the hosted game, to send the second copy of the universal interface plugin to the second player electronic device, such that the second copy of the universal interface plugin sent to the second player electronic device can be integrated with the first player user interface based on the second game launch request.

16. The remote wagering game system of claim 15, wherein the native remote gaming server is operable to provide the hosted game.

17. The remote wagering game system of claim 15, wherein the hosted game is a third party hosted game that is hosted by a third party remote gaming server.

18. The remote wagering game system of claim 17, wherein the universal interface plugin comprises:
a third party interface executable to receive input gaming data associated with the third party hosted game from the third party remote gaming server;
a first frontend interface executable to send first interface gaming data associated with the third party hosted game to the first player user interface, wherein the universal interface plugin is executable to translate the input gaming data to the first interface gaming data; and
a second frontend interface executable to send second interface gaming data associated with the third party hosted game to the second player user interface, wherein the universal interface plugin is executable to translate the input gaming data to the second interface gaming data.

19. The remote wagering game system of claim 18, wherein:
the native remote gaming server is operable to send a first copy of a game wrapper to the first player electronic device responsive to the first game launch request by the first player electronic device for the third party hosted game, wherein the first copy of the game wrapper is executable by the first player electronic device to enable the first frontend interface of the first copy of the universal interface plugin; and
the native remote gaming server is operable to send a second copy of the game wrapper to the second player electronic device responsive to the second game launch request by the second player electronic device for the third party hosted game, wherein the second copy of the game wrapper is executable by the second player electronic device to enable the second frontend interface of the second copy of the universal interface plugin.

20. The remote wagering game system of claim 18, wherein:
the native remote gaming server comprises a player account management (PAM) integrator that is specific to a PAM server and the native remote gaming server and enables communication between the native remote gaming server and the PAM server for player account operations provided by the PAM server; and
the native remote gaming server comprises a hub integrator executable to process data communicated between the PAM server and the third party remote gaming server to enable communication between the third party remote gaming server and the PAM server for the player account operations.
